(19) United States
(12) Patent Application Publication
(10) Pub. No.: US 2012/0130913 A1
(43) Pub. Date: May 24, 2012

(54) Pay-To-Play Compliance System and Method

(75) Inventors: Hugh Barrett, Springfield, MA (US); Mark Howland, Longmeadow, MA (US); Christopher Markowski, Feeding Hills, MA (US); Dennis Windoloski, Wilbraham, MA (US); Rhenita Brade, Springfield, MA (US)

(73) Assignee: Massachusetts Mutual Life Insurance Company, Springfield, MA (US)

(21) Appl. No.: 12/953,395

(22) Filed: Nov. 23, 2010

(51) Int. Cl. G06Q 99/00

(52) U.S. Cl. 705/317

(57) ABSTRACT

A system and method for ensuring compliance with pay-to-play laws. In one embodiment of the invention, the computer-implemented method of facilitating compliance with pay-to-play laws of different jurisdictions having varying requirements, comprises the steps of: creating, on a computer system, at least one question related to compliance with pay-to-play laws; storing, in a database, the at least one question related to compliance with pay-to-play laws; storing, in a database, at least one restriction related to compliance with pay-to-play laws; presenting the at least one question to a first user; receiving an answer from the user in response to the at least one question; determining a compliance status, using the computer system, based on a comparison between the answer and the at least one restriction; sending the compliance status to an output device of the computer system; and storing all inputted data and responses for reporting or regulatory compliance use.

### TECHNICAL FIELD

The present invention is in the field of computer-based systems and methods of ensuring compliance with laws. More particularly, the present invention is in the technical field of computer-based systems and methods in facilitating, determining and ensuring compliance with “pay to play” laws and regulations.

### BACKGROUND OF THE INVENTION

The United States federal government and all fifty states, directly or indirectly, prohibit bribery in obtaining government contracts. The federal government and many states and regulatory bodies have implemented so called “pay-to-play” restrictions through new or amended campaign finance, ethics, anti-bribery laws and/or regulations including procurement regulations, executive orders, policy statements, disclosure requirements, and contract terms or certifications (“pay to play restrictions”) to help regulate the influence that those who do business with a government entity can wield through political campaign contributions. Such “pay-to-play” restrictions limit state contractors or prospective state contractors, their affiliated entities including other companies or connected political action committees (separate segregated funds) and can even impact certain employees and covered family members ability to give a personal political contribution or undertake a solicitation on behalf of a candidate for office. Additionally, such “pay to play” restrictions may also require disclosure of certain current or past political contributions as a contingency of being awarded or maintaining a government contract, or as a means for regulators to ensure compliance with the applicable pay to play restrictions.

Ensuring compliance with all of these laws, however, can be difficult given the many differences that exist in the many state, local, and federal laws and regulations. This complexity is even more evident when a corporation or other business entity including but not limited to, limited liability companies, limited liability partnerships, partnerships, sole proprietorships or any other organized business concern conducts business activity in many jurisdictions, and must ensure that its employees and board directors comply with multiple “pay-to-play” restrictions at the same time. It is often not clear whether a state ethics agency, elections agency or state contracting agent is responsible for enforcing the law. It is also difficult for individual employees and board members and in some instances certain employees or board members covered family members who work for organizations affected by “pay-to-play” to determine their own eligibility to give personal political contributions to state, local, or government entities. Additional complexity is added due to variations in the pay to play restrictions including: different dollar limits and thresholds on the amount of a political contribution or solicitation; whether the entity seeking the governmental business is deemed by the applicable rule to meet the threshold of “contractor” or “prospective contractor” status and therefore covered by the rule; whether an employee is covered by the applicable rule due to their title or job function within the contracting entity; whether those employees or covered family members are legally entitled to vote for a particular government official or candidate for office; whether the candidate to whom the contribution is being made meets the definition of a covered official within the law or rule either by their title or ability to influence directly or indirectly the selection of the government contractor; and the timing of a political contribution in relation to the solicitation, request for proposal, or awarding of the contract.

Currently, many corporations utilize a legal compliance administrator, often a lawyer, who is familiar with the vast universe of different “pay-to-play” restrictions and is tasked with ensuring compliance both on an individual basis among the employees, and on company-wide basis. This administrator must field a large number of inquiries from employees seeking approval of their personal political contributions to avoid violating the “pay-to-play” restrictions. As the number and complexity of these restrictions increase, the job of the legal administrator becomes more complicated and burdensome. Simultaneously, the risks of non-compliance for the company and for the individual employees continue to increase, and can include civil and criminal penalties, loss of existing contracts or surrendering compensation or fees earned for those contracts, or being debarred from bidding on other governmental contracts for a certain time period.

The traditional method of utilizing a legal administrator to answer every employee question is a disadvantage because the administrator often must field a large volume of inquiries, many of which may be repeat questions from different employees that the administrator must answer. The legal administrator often must conduct research into an employee's inquiry and that research may be duplicated many times over if employees request pre-approval of similar personal political donations. The traditional method of using a legal administrator is also a disadvantage because the administrator must be manually answer every employee inquiry, which can be time-consuming and burdensome as the number of employee and employee inquiries increases. In addition, a manual system provides no easy means of recordkeeping requests and approvals for future reporting, auditing and disclosure to regulators.

The disclosed computer-based systems and methods of facilitating, determining and ensuring compliance with “pay to play” laws and regulations is directed to overcoming one or more of the problems listed above.

### SUMMARY OF THE INVENTION

In one aspect, the present invention disclosed herein is directed to a computer-implemented method of ensuring compliance with the pay-to-play laws of a plurality of jurisdictions having a plurality of requirements, comprising the steps of: creating, on a computer system, at least one question related to compliance with pay-to-play laws; storing, in a data store, the at least one question related to compliance with pay-to-play laws; creating, on a computer system, at least one restriction related to compliance with pay-to-play laws; storing, in a data store, the at least one restriction related to compliance with pay-to-play laws; presenting the at least one question to a first user; receiving an answer from the user in response to the at least one question; determining a compliance status, using the computer system, based on a comparison between the answer and the at least one restriction; sending the compliance status to an output device of the computer system; storing the compliance status and answers received from users; and retrieving stored compliance status and answers.

In another aspect, the present invention disclosed herein is directed to a computer program stored on a computer-readable memory device for controlling operations of a host computer, the computer program including instructions operable to receive at least one question from an administrator and to store said at least one question related to compliance with pay-to-play laws, instructions operable to receive at least one restriction from an administrator and to store at least one restriction related to compliance with pay-to-play laws, instructions operable to present stored at least one question to a user and to receive from said user at least one answer responsive to the at least one question, instructions operable to respond to the user's at least one answer by comparing said at least one answer to said at least one restriction, instructions operable to provide to the user, based said comparison, a compliance status, and instructions operable to provide the administrator with a report containing at least one of the following: the at least one question, the at least one restriction, the at least one answer, and the compliance status.

### BRIEF DESCRIPTION OF THE DRAWINGS

FIG. 1 is a diagram of an architecture for a typical system according to the present invention.

FIG. 2 is a flow chart of steps in a typical process according to the present invention.

FIG. 3 is another flow chart of steps in a typical process according to the present invention.

### DETAILED DESCRIPTION OF THE INVENTION

The present application is directed toward computer-based systems and methods of determining and ensuring compliance with “pay-to-play” laws and regulations.

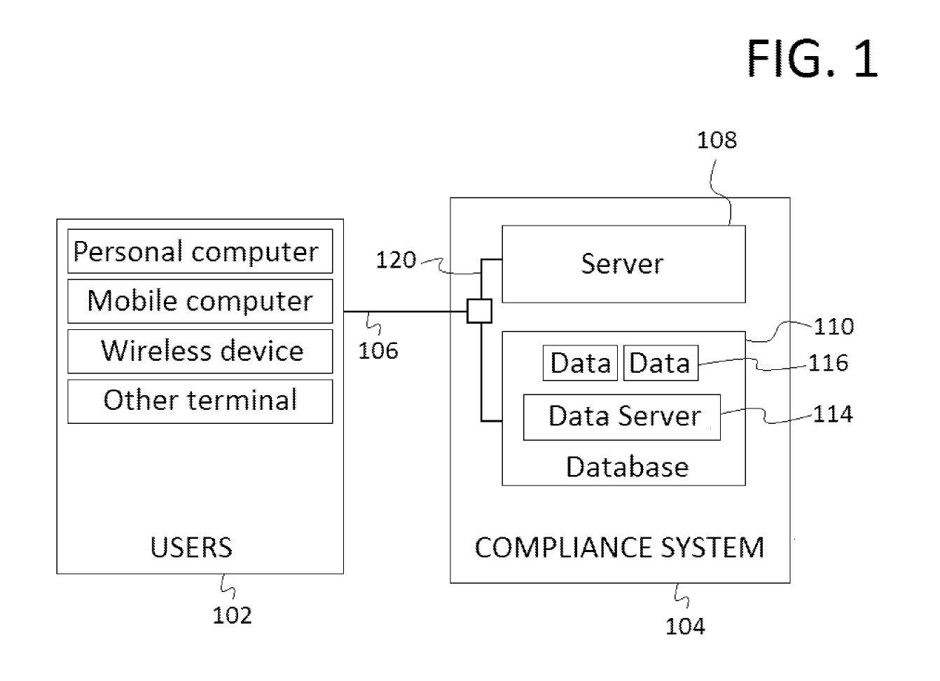

Referring now to FIG. 1, one embodiment of a system of the present invention is depicted. Users may use any one of a number of compatible devices 102 to interact with the compliance system 104 via an operative connection 106. Users of the compliance system include: legal administrators who formulate and maintain the questions, answer choices, and restrictions that will be used to generate an automated pre-approval decision based on an employee's responses to the questions; employees who will answer questions when prompted and receive an automated pre-approval decision; and any other users who may need access to the compliance system 104. Compatible devices 102 include personal computers, mobile computers, wireless devices, terminals, or any other type of electronic device. Devices 102 may include a keyboard, mouse, touch screen, or any other type of user input device, and may also include a monitor, television, printer, or any other type of output device.

As used in FIG. 1 and the following figures and descriptions, operative connection or operative communication includes any type of wired or wireless communication, including but not limited to the internet, local area networks, wide area networks, wireless networks, telephone lines, satellite communication, or any such type of electronic communication capable of transmitting and receiving data. In a preferred embodiment, operative connection 106 may comprise the Internet.

A typical compliance system 104 includes at least one server 108 for implementing and controlling compliance system 104. A typical compliance system 104 may also include at least one database 110 for storing data associated with the compliance system 104, such as questions, answers, employee response records, generated reports, compliance data, or any other electronic record desired to be stored. Database 110, in a typical embodiment, may use one or more data servers 114 and one or more internal or external data storage devices 116, as described below.

The compliance system 104 may also include an operative connection 120, such as an internal Ethernet network, which supports communication between the various components of the compliance system 104. Operative connection 120 may include any suitable communication architecture including, but not limited to, a computer network such as a Ethernet, token ring network or the Internet; a direct connection such as a bus connection, parallel or serial connection, null modem connection, dedicated line or wireless connection utilizing an appropriate communication protocol known in the art. In embodiments where a single computer may provide all functional components of compliance system 104, the communication along operative connection 120 may occur via bus connections, inter-process communication, shared files or some combination of these methods or other commonly used single-computer communication mechanisms.

The compliance system 104 may include at least one server 108 that provides compliance system functionality. This, or other servers (not shown), may enable and support access to the compliance system by the users utilizing compatible devices 102. Access to the compliance system by these users may be via any suitable operative connection 106, which in one preferred embodiment will be a computer network such as the Internet. In other embodiments, access may be via other forms of computer network, direct dial-up connection, dedicated connection, direct or indirect connection such as via a bus connection, parallel or serial connection, null modem connection or wireless connection utilizing an appropriate communication protocol known to those skilled in the art. The at least one server 108 may include or connect to database 110. In one embodiment, server 108 and database 110 may be joined together in a single computer system that comprises compliance system 104. The conveyance of data and information to and from users using devices 102 occurs via the operative connection 106.

The compliance system 104, as shown in FIG. 1, uses both operative connection 106 and operative connection 120 as communication channels allowing access to the compliance systems 104 by users using devices 102. A router (not shown) may be included in the compliance system 104 to manage communication within the internal operative connection 120 as well as to manage the interface between the internal operative connection 120 and the operative connection 106. In another embodiment, operative connection 106 and operative connection 120 may comprise a single communication device or channel.

The at least one server 108 may provide the desired functionality of the compliance system 104. In some embodiments, the server 108 may be divided into access servers and application servers where the access servers provide electronic access functionality such as by electronic mail server(s) and/or Web server(s) and the application servers provide the desired system functionality. In some embodiments, system and/or access functionality may be distributed across multiple processing elements. The term processing element may be a process running on a particular piece, or across particular pieces, of hardware, a particular piece of hardware or either as the context allows.

The database 110 provides for the storage and the management of the data required by the compliance system 104. In one embodiment, a database 110 may include one or more storage devices 116, and in some embodiments, may also include one or more data servers 114 to receive and service data requests. The database depicted in FIG. 1 uses one data server 114 and several data storage devices 116. The data storage devices 116 may be located internally or externally. These depictions are representative only, and other database architectures of the present invention may comprise single, multiple and/or varied servers and storage elements. In embodiments where a single processor supports all functionality of the compliance system 104, a local hard disk drive may serve as the database 110 and a disk operating system executing on the single processor acting as a data server may support receive and service data requests.

Information concerning different users (including legal administrators, legal reviewers, and employees) and all data necessary to implement the present invention (questionnaire records, employee answer records, compliance restrictions) may be stored in the database 110. In some embodiments, content supporting the compliance process and policy determinations may be developed, provided and maintained by a legal administrator. In such embodiments, this content may be stored in database 110, and may be updated on a periodic basis, as required by changes in law, upon demand, or at any time as determined by the legal administrator. In another embodiment, user access data is stored in a secondary storage mechanism, separate from the database 110.

The compliance system 104 may also provide a mechanism for a legal administrator 201 to input restrictions in such a way that is meaningful to the legal administrator 201 and also easily accessible for the compliance system 104 for evaluation. In one embodiment the compliance system 104 would assign all relevant political entities a unique identifier and allow the legal administrator 201 to select a combination of such identifiers that would result in a “not permissible” decision for the users of the system. In such an embodiment, a separate system could be used to automatically receive feeds from public sources to populate said political entities and their identifiers. In another embodiment, the legal administrator 201 could input a set of free-form conditions for the compliance system 104 to interpret and check, these conditions could include a custom grammar specifically designed for the purpose of evaluation, such as “amount>$1000” or “firstname is john and lastname is smith”.

In one embodiment, compliance system 104 may include additional operative connections to enable additional functionality and interactions with existing hardware and software (both company and third-party). For example, compliance system 104 may include a database link to a sale database, contact database, contract database, client database, or other internal databases to compare proposed recipient of contributions (i.e., candidate for elected or appointed office) is an official of an existing governmental client.

In another embodiment, compliance system 104 may be accessed via an external password protected website to allow candidates for employment to report or log their past contributions into compliance system 104, which would then compare any past contributions with applicable laws and regulations input by legal administrator 201, such as those regarding various look-back provisions in the pay-to-play laws or regulations.

It will be understood by those of skill in the art that these different types of information and data may be logically or physically segregated within a single system database; multiple related databases accessible through a unified management system, which together serve as the system database; or multiple independent databases individually accessible through disparate management systems, which may in some embodiments be collectively viewed as the system database. The various storage elements that comprise the physical architecture of the system database may be centrally located, or distributed across a variety of diverse locations.

Various methods and functions as exhibited in various embodiments according to the present invention are described below with respect to “pay-to-play” compliance including automated pre-approval of employee personal political contributions based on restrictions input by the legal administrator, review of the automated pre-approval decisions, and manual modification or override of the automated pre-approval decision as deemed necessary by the legal administrator. In some embodiments, one or more processors within architectures of the environments as described above may execute the steps in such methods and provide such functionality. The functionality may be spread across multiple processing elements; in certain embodiments, these processing elements may logically and/or physically be divided into access, compliance logic and data storage processing elements where functionality is allocated appropriately among such processing elements. In other embodiments, any suitable computer readable storage device, including primary storage such as RAM, ROM, cache memory, etc. or secondary storage such as magnetic media including fixed and removable disks and tapes; optical media including fixed and removable disks whether read-only or read-write; or other secondary storage as would be known to those skilled in the art, may store instructions that upon execution by one or more processors cause the one or more processors to execute the steps in such methods and to provide such functionality.

### “Pay-To-Play” Law Compliance, Evaluation, Review and Establishment

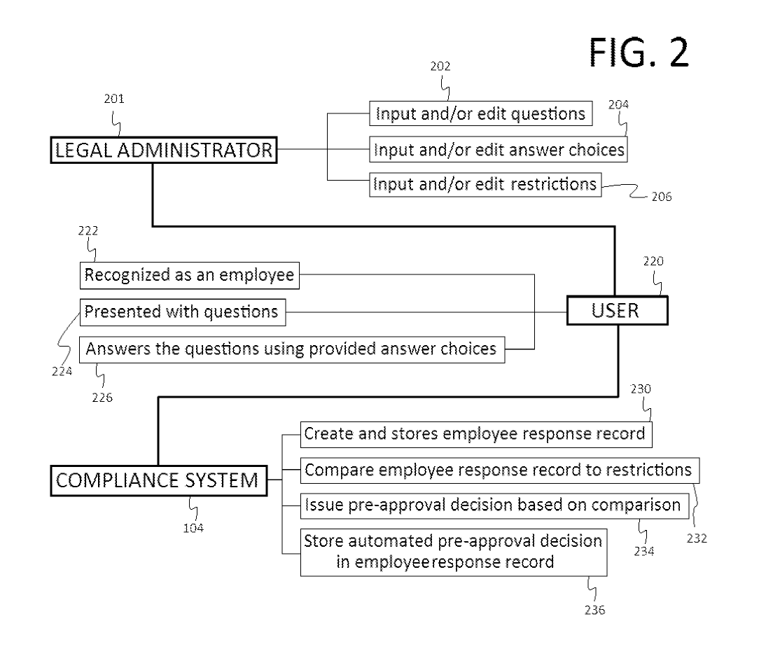

FIG. 2 is a flow chart depicting the steps in one possible embodiment of the present invention. A legal administrator 201, using a compatible device 102, accesses the compliance system 104. The legal administrator 201 inputs or edits a number of questions at 202 that will be presented to employees who seek pre-approval of their personal political contributions. The questions may inquire about, for example: the planned jurisdiction of the contribution; the planned recipient of the contribution; the company, department, or group in which the employee works; the employee's title in the company; whether the employee works in sales, marketing, business development, or a similar job; whether the employee's job responsibilities include investment advisory functions; whether the employee's job responsibilities include managerial oversight of public contracts or investments, whether the employee's job responsibilities require them to interact with public officials, state, local or municipal agencies regarding sales or contract matters, and whether the employee requesting clearance is requesting it on behalf of themselves or a covered family member. In addition to inputting and editing questions, at 204 the legal administrator also chooses from a variety of answer formats that the application would present to an employee for each question. For example, questions may have multiple choice answers, free form answers in which an employee can input a custom answer, yes/no answers, or any other combination of answer choices which the legal administrator deems appropriate for a given question. Additionally, after the initial list of questions and answers are created at 202 and 204, the legal administrator may return to those steps, at any time, to further input or edit the questions and answers. Such edits include inputting new questions, updating current questions, deleting current questions, and changing the available answer options presented to a user.

Once the questions and answers have been created by the legal administrator 201 and are stored within the compliance system database 110, the legal administrator 201 also inputs and edits any number of restrictions at 206 that, based at least in part on an employee's answers to a question or a combination of questions, will generate either a “not permissible” compliance status, notifying that employee that the planned political contribution is not allowed, or a “permissible” compliance status, indicating at least an initial approval of the planned political contribution.

Subsequently, a user 220, using a compatible device 102, accesses the compliance system 104 and is recognized as an employee at 222. This recognition may consist of a login name and password, encryption technique, or any other method of recognition. Once recognized as an employee, the user 220 is presented with the questions at 224 created by the legal administrator 201. The user 220 may then answer the questions using the provided answer choices at 226.

In one embodiment, compliance system 104 may include additional operative connections to enable additional functionality and interactions with existing hardware and software (both company and third-party). For example, compliance system 104 may include an operative connection to the company's Human resources software to confirm the job title and/or employing entity of a user 102 and also to automate portions of the answering step at 226. As another example, compliance system 104 may include an operative connection to an external database to compare user 102's address (obtained from user 102 or a human resources database) to a list of addresses or a range of addresses entitled to vote for specific candidates. Such a feature would facilitate compliance with laws or regulations establishing different contribution limits based on an employee's residence and ability to vote for specific candidates. In another embodiment, compliance

Once the user 220 has provided an answer to the questions at 226, the compliance system 104 creates an employee response record and store the answers and any other desired additional information in the employee response record at 230. The compliance system 104 may then compare the employee response record at 230 to the restrictions input by the legal administrator 201 at 206 to determine the appropriate compliance status at 232. Once the employee response record and the restrictions have been compared, the compliance system 104 may provide the user 220 with a compliance status decision based on the comparison. For example, if a user 220 indicates through his answers at 226 that he would like to donate $1000 to a candidate running for state representative in Connecticut, and the legal administrator 201 has input a restriction at 206 that does not permit contributions to state representative candidates in Connecticut in excess of $500, the compliance system 104 will return a “not permissible” compliance status at 234 to the user 220. If, however, a user's answers at 226 do not violate any of the input restrictions at 206 created by the legal administrator 201, the compliance system 104 may issue a “permissible” compliance status at 234 indicating to the user 220 that their planned political contribution does not violate any of the “pay-to-play” restrictions currently input by the legal administrator 201 into the compliance system 104. Once complete, the compliance system 104 may store the determined compliance status it issued to user 220 in the employee response record at 236.

Compliance system 104 may also include an automated notification system (not shown) which enables a user 102 to confirm, at a later date, after the contribution, the date, amount, and recipient of a contribution. For example, the automated notification system may communicate with user 102 (using email, text message, or any other electronic communication) a set number of days after the initial determination of compliance status. The communication would require user 102 to reply to the communication to verify the details of the contribution to comply with record-keeping requirements of applicable laws and regulations. Failure of user 102 to confirm the contribution may result in any future requests for pre-approval of a compliance status being denied or blocked.

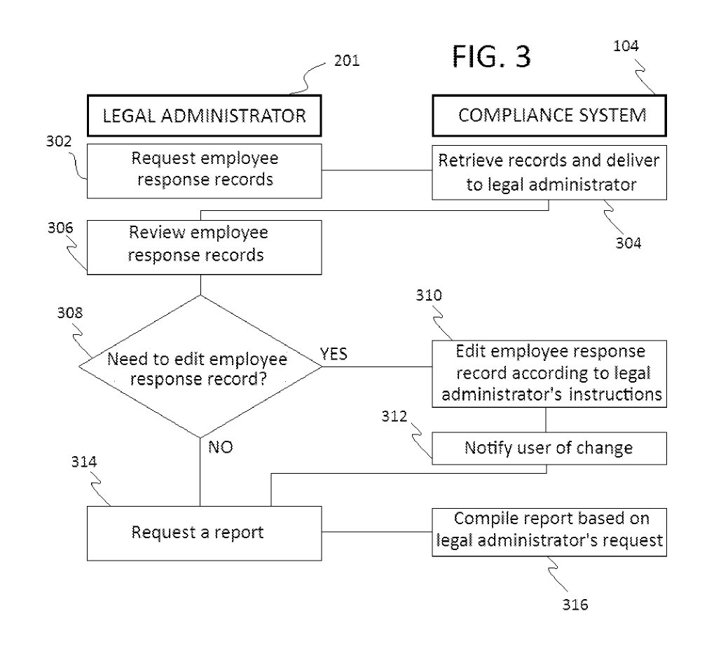

Referring now to FIG. 3, a flowchart is depicted that describes the steps in another embodiment of the present invention. The legal administrator 201 may access the compliance system 104 using any compatible device 102 and may request access to an individual employee response record or to a group of employee response records at 302. The compliance system 104 then verifies that the legal administrator 201 is authorized to view and edit the records, and upon verification, retrieves the requested records and displays them to the legal administrator 201 at 304. The legal administrator 201 may then review the employee response records at 306 and may elect to edit the pre-approval decision or add any necessary comments to the employee response record at 308. For example, if a user 220 had been issued a “not permissible” compliance status from the compliance system 104 when she first provided her answers, but circumstances have changed such that her planned political contribution would now be permissible, the legal administrator 201 can change the compliance status from “not permissible” to “permissible” at 310. Once this is completed, the legal administrator 201 may authorize the compliance system 104 to notify the user 220 of the change at 312. Alternatively, the compliance system 104 may automatically notify the user 220 of the change. Such a notification may be via email, text message, or any other type of communication.

The legal administrator 201 may then send a request at 314 to the compliance system 104 to generate a report including all of the information from all of the employee response records within the database 110, or as much of the information as the legal administrator 201 requests. The report may include numerical data, text data, delimiters, headers, or other information, and the compliance system 104 may export the data to a spreadsheet application such as Microsoft Excel, or other software applications for additional review, analysis, reporting or presentation. For example, the legal administrator 201 may request a report which contains all of the answers contained in the employee response records in which an employee wished to make a personal political contribution in a specific state or to a specific office. In another embodiment, the legal administrator 201 may request generation of an report containing only the employee names and the jurisdictions in which they requested approval for personal political contributions. Any combination of the data contained in the employee response records may be used by the compliance system 104 to generate a custom report at 316.

The embodiments described above are given as illustrative examples only. It will be readily appreciated by those skilled in the art that many deviations may be made from the specific embodiments disclosed in this specification without departing from the invention. Accordingly, the scope of the invention is to be determined by the claims below rather than being limited to the specifically described embodiments above.

What is claimed is:

1. A computer-implemented method of complying with a plurality of pay-to-play laws of a plurality of jurisdictions having a plurality of requirements, comprising the steps of:
creating, by a first user on a computer system, at least one question related to compliance with pay-to-play laws;
storing, in a database, the at least one question related to compliance with pay-to-play laws;
creating, by a second user on a computer system, at least one restriction related to compliance with pay-to-play laws;
storing, in a database, the at least one restriction related to compliance with pay-to-play laws;
presenting, by a computer system, the at least one question to a third user;
receiving at least one answer from the third user in response to the at least one question;
storing, in a database, the at least one answer from the third user;
determining a compliance status, using the computer system, based on a comparison between the stored answer and the stored at least one restriction; and
sending the compliance status to an output device of the computer system.

2. The method of claim 1, wherein said third user is an employee.

3. The method of claim 1 wherein said step of sending the compliance status to an output device of the computer system comprises the step of displaying the compliance status on a monitor of the computer system.

4. The method of claim 1 wherein said step of creating at least one question includes the steps of:
obtaining question information from the first user of said computer system; and
obtaining answer information from the first user of said computer system.

5. The method of claim 3, wherein said first user of said computer system is a legal administrator.

6. The method of claim 3, further comprising the step of allowing an update of the at least one restriction based on a change in the pay-to-play laws of at least one jurisdiction.

7. The method of claim 6, further comprising:
storing said compliance status in the database; and
outputting said compliance status to said third user.

8. The method of claim 7, further comprising:
permitting an authorized user to review and edit at least one of the following: the stored at least one question, stored at least one restriction, stored at least one answer, and stored compliance status; and
receiving a request from said authorized user to generate a report based upon and including at least one of the following: the stored at least one question, stored at least one restriction, stored at least one answer, and stored compliance status.

9. The method of claim 8, further comprising notifying said third user of an edit to the stored at least one answer or the stored compliance status.

10. A computer program stored on a computer-readable memory device for controlling operations of a host computer, the computer program comprising:
instructions operable to receive at least one question related to compliance with pay-to-play laws from an administrator and to store said at least one question;
instructions operable to receive at least one restriction related to compliance with pay-to-play laws from an administrator and to store at least one restriction;
instructions operable to present stored at least one question to a user and to receive from said user at least one answer responsive to the at least one question;
instructions operable to respond to the user's at least one answer by comparing said at least one answer to said at least one restriction; and
instructions operable to provide to the user, based on said comparison, a compliance status.

11. The computer program of claim 10, further comprising instructions operable to provide the administrator with a report containing at least one of the following: the at least one question, the at least one restriction, the at least one answer, and the compliance status.

12. The computer program of claim 11, further comprising:
instructions operable to receive from the administrator a request to review and edit at least one of the following: the stored at least one question, the stored at least one restriction, the stored at least one answer, and the stored compliance status; and
instructions operable to notify the user if the administrator edits at least one stored answer or the stored compliance status.
